(19) United States
(12) Patent Application Publication
(10) Pub. No.: US 2006/0130880 A1
(43) Pub. Date: Jun. 22, 2006

(54) Substrate treating apparatus and method

(75) Inventor: Shuzo Nagami, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/299,605

(22) Filed: Dec. 12, 2005

(30) Foreign Application Priority Data
Dec. 16, 2004 (JP) 2004-364312

(51) Int. Cl. B08B 3/00

(52) U.S. Cl. 134/26; 134/30; 134/94.1

(57) ABSTRACT

A mixer produces a treating solution by mixing chloride into hot deionized water heated by a hot water unit. The treating solution produced is supplied to a treating tank through a treating solution pipe and a common pipe. In the treating tank, substrates held by a lifter are immersed in the treating solution. Subsequently, the lifter is raised to pull the substrates up from the treating solution. Since the droplets adhering to the substrates are acid, an oxidation reaction of the substrates is inhibited. That is, when the substrates dry, an oxide does not deposit on the substrates, thereby preventing formation of watermarks.

### BACKGROUND OF THE INVENTION

(1) Field of the Invention

This invention relates to a substrate treating apparatus and substrate treating method for treating substrates such as semiconductor wafers and glass substrates for liquid crystal displays (hereinafter simply called substrates).

More particularly, the invention relates to a technique for drying such substrates.

(2) Description of the Related Art

After each of exposing, developing and etching treatments of substrates, cleaning and drying treatments are carried out to remove a chemical solution used in the preceding treatment from the substrates.

A substrate drying apparatus has been proposed, in which substrates are immersed and heated in deionized water controlled to a high temperature (hereinafter called “hot deionized water” where appropriate), and are thereafter pulled up out of the hot deionized water (as disclosed in Japanese Unexamined Patent Publication H1-130771 (1989), for example). The principle of this pull-up drying is that the substrates pulled up out of the hot deionized water are dried by transferring the thermal energy stored in the substrates to droplets adhering to the substrates.

The substrates pulled up from the hot deionized water are exposed to the surrounding atmosphere. At this time, oxygen present in the surrounding atmosphere dissolves in the droplets on the surfaces of the substrates, and spreads to the interfaces between the substrates and droplets. On the substrate surfaces, the oxygen causes an oxide generating reaction of the substrates. As a result, the oxide of the substrate forms deposits after drying, producing what is called watermarks.

To avoid this inconvenience, an apparatus has been proposed, which uses an inactive gas as the atmosphere surrounding substrates pulled up (as disclosed in Japanese Unexamined Patent Publication No. 2004-165624, for example). This measure can inhibit generation of watermarks.

Inventors herein have conducted a detailed study of the watermark generating mechanism, and made the following considerations. For convenience of description specifically using chemical formulas, the substrates are assumed to consist of a material containing silicon.

<Step 1> The substrates immersed in hot deionized water are pulled up from the hot deionized water. The substrates are exposed to the surrounding atmosphere, and droplets (of the hot deionized water) adhere to the substrates. Oxygen present in the surrounding atmosphere dissolves in the droplets on the substrates, and spreads to the interfaces between the substrates and droplets.

<Step 2> On the substrate surfaces, an oxide generating reaction (hereinafter called “oxidation of the substrates”) shown in chemical formula (1) and chemical formula (2) takes place.
Si+O₂+4H₂O→SiO₂+4H⁺+4OH⁻ (1)
Si+2O₂+2H₂O→SiO₂+2H⁺+2HO₂⁻ (2)

As seen from chemical formula (1) and chemical formula (2), the oxidation of the substrates is accompanied by generation of hydrogen ions.

The oxidation of the substrates shown in chemical formula (1) is due to half equations shown in chemical formula (3) and chemical formula (4) occurring in parallel.
Si+2H₂O→SiO₂+4H⁺+4e⁻ (3)
O₂+2H₂O+4e⁻→4OH⁻ (4)

The oxide generating reaction shown in chemical formula (2) is due to the half equations shown in chemical formula (3) and chemical formula (5) occurring in parallel.
2O₂+2H₂O+4e⁻→2HO₂⁻+2OH⁻ (5)

<Step 3> Silicon dioxide (SiO2) generated hydrates to produce silicic acid. This reaction is expressed by chemical formula (6).
SiO₂+H₂O→H₂SiO₃ (6)

<Step 4> The silicic acid dissolves in water droplets, and spreads and dissociates. The reaction is shown in chemical formula (7) and chemical formula (8).
H₂SiO₃→H⁺+HSiO₃⁻ (7)
HSiO₃⁻→H⁺+SiO₃²⁻ (8)

The generation of oxide is again promoted by diffusion and dissociation of the silicic acid.

<Step 5> After drying, this oxide remains on the substrate surfaces as deposits, and becomes watermarks.

### SUMMARY OF THE INVENTION

Inventors have directed their attention to the oxidation of the substrates shown in chemical formula (1) and chemical formula (2), and made intensive research from the viewpoint of inhibiting such reaction.

This invention has been made having regard to the state of the art noted above, and its object is to provide a substrate treating apparatus and substrate treating method for drying substrates, while inhibiting generation of watermarks.

The above object is fulfilled, according to this invention, by a substrate treating apparatus comprising a treating tank for treating substrates; a treating solution supply device for supplying the treating tank with a treating solution having hydrogen ions added to hot deionized water; and a holding device vertically movable, while holding the substrates, between a treating position in the treating tank and a standby position above the treating tank; wherein the treating solution is stored in the treating tank, and the holding device is raised from the treating position to the standby position to perform drying treatment of the substrates.

According to this invention, hydrogen ions are added to hot deionized water, whereby the treating solution contains a larger quantity of hydrogen ions than the quantity of hydrogen ions normally present in deionized water. That is, the treating solution is acid. Consequently, a chemical reaction accompanied by generation of hydrogen ions does not take place since it would further destabilize the system of the treating solution. Further, the holding device in the treating position immerses the substrates in the treating solution, whereby thermal energy is given to the substrates from the treating solution including the hot deionized water. The substrates store this thermal energy.

As the holding device is raised to the standby position, the substrates are pulled up out of the treating solution. The substrates pulled up have droplets adhering thereto, and are exposed to the surrounding atmosphere. The surrounding atmosphere contains oxygen necessary for oxidation of the substrates. The oxidation is accompanied by generation of hydrogen ions. The droplets adhering to the substrates are those of the treating solution. Thus, drying of the substrates due to the thermal energy stored in the substrates progresses with no oxidation of the substrates taking place. Since no oxide of the substrates is generated, the substrates are free from oxide deposits. Consequently, the drying treatment of the substrates is performed while preventing formation of watermarks.

Preferably, the treating solution is an aqueous solution having an acid added to the hot deionized water. With an acid added to the hot deionized water, the acid ionizes to generate hydrogen ions. In this way, hydrogen ions may be added to the hot deionized water suitably.

Preferably, the acid is a strong acid. A strong acid has an advantage of a large part thereof ionizing in the treating solution to produce a large quantity of hydrogen ions. In this way, a large quantity of hydrogen ions may be added to the hot deionized water.

The acid may be chloride or hydrofluoric acid.

By selecting chloride or hydrofluoric acid to be added, a suitable treating solution may be produced.

The apparatus according to this invention may further comprise an adding device for adding the acid to the hot deionized water. The adding device can produce the treating solution from the hot deionized water and acid.

Preferably, the treating solution is at a temperature of at least 80° C. but below 100° C. Then, the treating solution can give sufficient thermal energy to the substrates to realize an excellent drying performance.

The apparatus according to this invention may further comprise a control device for controlling supply of the treating solution and vertical movement of the holding device, to store the treating solution in the treating tank, and to raise the holding device from the treating position to the standby position. This control device will assure effective drying of the substrates.

The apparatus may further comprise an outer tank surrounding an upper potion of the treating tank for collecting the treating solution overflowing the treating tank, the treating solution supply device introducing the treating solution into the treating tank from bottom positions thereof. This construction does not allow particles and the like separating from the substrates to remain in the treating tank, thereby preventing the particles and the like from re-adhering to the substrates.

The apparatus may further comprise a hot water unit for supplying the hot deionized water. The hot water unit will provide the hot deionized water in a convenient way.

The adding device may comprise a mixer. The mixer will produce the treating solution in a convenient way.

The apparatus may further comprise a blower mechanism disposed above the treating tank for blowing an inert gas downward. This construction can dry the substrates effectively while inhibiting oxidation of the substrates.

The blower mechanism may include a ULPA filter disposed on a blow-off plane thereof. This filter can remove particles from the inert gas.

The apparatus may further comprise a deionized water supply device for supplying deionized water into the treating tank. Then, the substrates may receive deionized water cleaning treatment in the treating tank. The apparatus may further comprise a chemical solution supply device for supplying a chemical solution into the treating tank. Then, the substrates may receive chemical treatment in the treating tank.

In another aspect of the invention, a substrate treating method is provided, which comprises a step of immersing substrates in a treating solution having hydrogen ions added to hot deionized water; and a step of performing drying treatment of the substrates by pulling the substrates up from the treating solution. According to this invention, hydrogen ions are added to hot deionized water, whereby the treating solution contains a larger quantity of hydrogen ions than the quantity of hydrogen ions normally present in deionized water. That is, the treating solution is acid. Consequently, a chemical reaction accompanied by generation of hydrogen ions does not take place since it would further destabilize the system of the treating solution. Further, the substrates are immersed in the treating solution, whereby the substrates store thermal energy transferred from the treating solution including the hot deionized water.

As the substrates are pulled up from the treating solution, the substrates have droplets adhering thereto, and are exposed to the surrounding atmosphere. The surrounding atmosphere contains oxygen necessary for oxidation of the substrates. The oxidation is accompanied by generation of hydrogen ions. The droplets adhering to the substrates are those of the treating solution. Thus, drying of the substrates due to the thermal energy stored in the substrates progresses with no oxidation of the substrates taking place. Since no oxide of the substrates is generated, the substrates are free from oxide deposits. Consequently, the drying treatment of the substrates is performed while preventing formation of watermarks.

Preferably, the treating solution is an aqueous solution having an acid added to the hot deionized water. With an acid added to the hot deionized water, the acid ionizes to generate hydrogen ions. In this way, hydrogen ions may be added to the hot deionized water suitably.

Preferably, the acid is a strong acid. A strong acid has an advantage of a large part thereof ionizing in the treating solution to produce a large quantity of hydrogen ions. In this way, a large quantity of hydrogen ions may be added to the hot deionized water.

The acid may be chloride or hydrofluoric acid. By selecting chloride or hydrofluoric acid to be added, a suitable treating solution may be produced.

Preferably, the treating solution is at a temperature of at least 80° C. but below 100° C. Then, the treating solution can give sufficient thermal energy to the substrates to realize an excellent drying performance.

The step of performing drying treatment, preferably, is executed while causing an inert gas to flow downward from above the substrates. Then, the substrates may be dried effectively while inhibiting oxidation of the substrates.

This specification discloses also an invention relating to the following substrate treating apparatus:

(1) A substrate treating apparatus for drying substrates having undergone cleaning treatment, comprising a treating tank; a treating solution supply device for supplying the treating tank with a treating solution including hot deionized water; a lift device vertically movable, while holding the substrates, between a position in the treating tank and a position above the treating tank; and a control device for controlling the treating solution supply device and the lift device, to store the treating solution in the treating tank, and to pull up the substrates immersed in the treating solution from the treating solution; wherein the treating solution is acid.

According to the invention set out in paragraph (1) above, since the treating solution is acid, the treating solution contains a larger quantity of hydrogen ions than the quantity of hydrogen ions normally present in deionized water. Thus, this apparatus has similar functions to those of the apparatus defined in claim 1.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a view in vertical section showing an outline of a substrate treating apparatus in a first embodiment;

FIG. 2 is a flow chart showing operation of the substrate treating apparatus in the first embodiment;

FIG. 3 is a view in vertical section showing an outline of a substrate treating apparatus in a second embodiment; and

FIG. 4 is a flow chart showing operation of the substrate treating apparatus in the second embodiment.

### DESCRIPTION OF THE PREFERRED EMBODIMENTS

### First Embodiment

An embodiment of this invention will be described hereinafter with reference to the drawings.

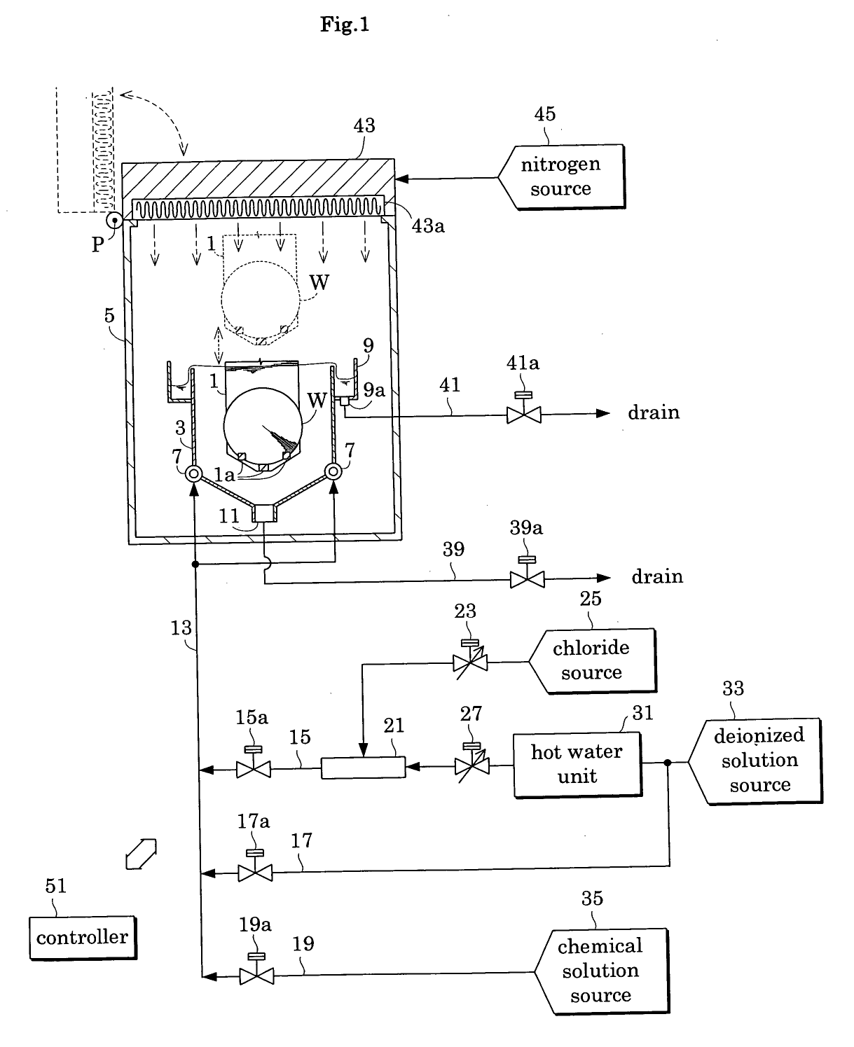

FIG. 1 is a view in vertical section showing an outline of a substrate treating apparatus in a first embodiment.

This substrate treating apparatus performs cleaning treatment of a group of substrates or wafers W with a chemical solution, cleaning treatment of the wafers W with deionized water for removing the chemical solution from the wafers W, and drying treatment for drying the deionized water adhering to the wafers W.

The substrate treating apparatus includes a lifter 1 for holding the wafers W, a treating tank 3 for performing the above predetermined treatments of the wafers W, and a chamber 5 for accommodating the lifter 1 and treating tank 3.

The lifter 1 has three support members 1a extending horizontally. The lifter 1 holds the wafers W in vertical posture, with the support members 1a contacting and supporting lower edges of the wafers W. The lifter 1 is vertically movable by a drive mechanism not shown, between a treating position in the treating tank 3 (as shown in solid lines in FIG. 1) and a standby position above the treating tank 3 (as shown in dotted lines in FIG. 1). The lifter 1 corresponds to the holding device in this invention.

The treating tank 3 stores the chemical solution, deionized water or a treating solution containing deionized water for performing the cleaning treatment and drying treatment. The treating tank 3 includes filling pipes 7 arranged in the bottom thereof for supplying the treating solutions to the treating tank 3. An outer tank 9 surrounds an upper portion of the treating tank 3 for collecting the treating solutions overflowing the treating tank 3. The treating tank 3 further includes a drain port 11 disposed in a lowermost position in the bottom thereof for draining off the treating solutions. The treating tank 3 corresponds to the treating tank in this invention.

Ends of a common pipe 13 are connected to the filling pipes 7. A treating solution pipe 15, a deionized water pipe 17 and a chemical solution pipe 19 are connected in parallel with one another to the other end region of the common pipe 13. These treating solution pipe 15, deionized water pipe 17 and chemical solution pipe 19 have electromagnetic switch valves 15a, 17a and 19a mounted thereon, respectively. The common pipe 13 and treating solution pipe 15 correspond to the treating solution supply device in this invention. The common pipe 13 and deionized water pipe 17 correspond to the deionized water supply device in this invention. The common pipe 13 and chemical solution pipe 19 correspond to the chemical solution supply device in this invention. The common pipe 13 serves as the treating solution, deionized water and chemical solution supply devices.

A mixer 21 is connected to the other end of the treating solution pipe 15. A chloride source 25 is connected to the mixer 21 through a flow control valve 23, while a deionized water source 33 is connected to the mixer 21 through a flow control valve 27 and a hot water unit 31.

The hot water unit 31 has a heater (not shown). The heater performs a temperature control to heat deionized water supplied from the deionized water source 33 to a predetermined temperature. The hot water unit 31 has a deaerator also for removing bubbles and the like from the deionized water having undergone the temperature control. The apparatus may further include a tank for the deionized water, to form a constant temperature bath.

The apparatus supplies the hot deionized water heated to the predetermined temperature by the hot water unit 31. In this embodiment, the temperature of the deionized water is set to 85° C. However, the temperature of the hot deionized water is not limited to this, but is selected as appropriate. Considering the performance of drying the wafers W, the temperature of the hot deionized water, preferably, is 80° C. or higher but below 100° C.

The mixer 21 mixes chloride into the hot deionized water supplied from the hot water unit 31. In this specification, an aqueous solution with acid added to the hot deionized water is called “treating solution”. The mixer 21 corresponds to the adding device in this invention.

The deionized water source 33 noted above is connected also to the other end of the deionized water pipe 17.

A chemical solution source 35 is connected to the other end of the chemical solution pipe 19. In this embodiment, the apparatus includes one chemical solution source 35. However, the construction may be modified to include two or more types of chemical solution sources 35 according to purpose of treatment of the wafers W.

Examples of chemical solution include APM (Ammonia-Hydrogen Peroxide Mixture), HPM (Hydrochloric acid-Hydrogen Peroxide Mixture), FPM (Hydrofluoric acid-Hydrogen Peroxide Mixture), DHF (Diluted Hydrofluoric acid) and O₃/DIW (ozone water). An appropriate one of these may be selected.

A pipe 39 is connected to the drain port 11. The pipe 39 has an electromagnetic switch valve 39a mounted thereon. A liquid is drained from the treating tank 3 by opening the switch valve 39a.

The outer tank 9 has an outer tank drain port 9a formed in the bottom thereof. A pipe 41 having an electromagnetic switch valve 41a is connected to the outer tank drain port 9a. A liquid is drained from the outer tank 9 by opening the switch valve 41a.

A blower mechanism 43 is installed at the top of the chamber 5. The blower mechanism 43 is in the form of a flat box having one side thereof connected to a nitrogen source 45. The blower mechanism 43 has a perforated bottom defining a blow-off plane. Thus, the blower mechanism 43 has a construction for blowing nitrogen at a constant velocity down through the blow-off plane. Nitrogen is an example of inert gas, and the blower mechanism 43 may be adapted to blow off a different type of inert gas as appropriate.

A ULPA (Ultra Low Penetration Air) filter 43a is installed on the blow-off plane. The ULPA filter 43a removes fine particles from the nitrogen.

The blower mechanism 43 is pivotable about an axis P. The wafers W are loaded into and unloaded from the apparatus when the blower mechanism 43 has pivoted to a position for opening the top of the chamber 5 (i.e. when the blower mechanism 43 is in the position shown in dotted lines in FIG. 1). The chamber 5 is in a sealed state when the blower mechanism 43 closes the top of the chamber 5 (i.e. when the blower mechanism 43 is in the position shown in solid lines in FIG. 1). In this state, the apparatus may perform the predetermined treatment of wafers W.

A controller 51 is disposed inside the substrate treating apparatus for performing an overall control of the treatment of wafers W based on predetermined treating conditions. Specifically, the controller 51 causes pivotal movement of the blower mechanism 43 and vertical movement of the lifter 1, to control loading and unloading of the wafers W and position of the wafers W. The controller 51 controls supply of the treating solution, deionized water and chemical solution by operating the switch valves 15a, 17a and 19a, to select a liquid to be fed to the common pipe 13 as appropriate. The controller 51 also controls draining of liquids from the treating tank 3 and outer tank 9 by operating the switch valves 39a and 41a. Further, the controller 51 operates the hot water unit 31 to control the temperature of hot deionized water obtained. The controller 51 operates the flow control valves 23 and 27 to control the quantity of chloride added to the hot deionized water (i.e. a ratio between hot deionized water and chloride). The controller 51 also operates the nitrogen source 45 to control the blow-off of nitrogen. This controller 51 is made up of a central processing unit (CPU) that performs various computations for substrate treatment, and a storage medium that stores the predetermined treating conditions and a variety of information required for substrate treatment. The controller 51 corresponds to the control device in this invention.

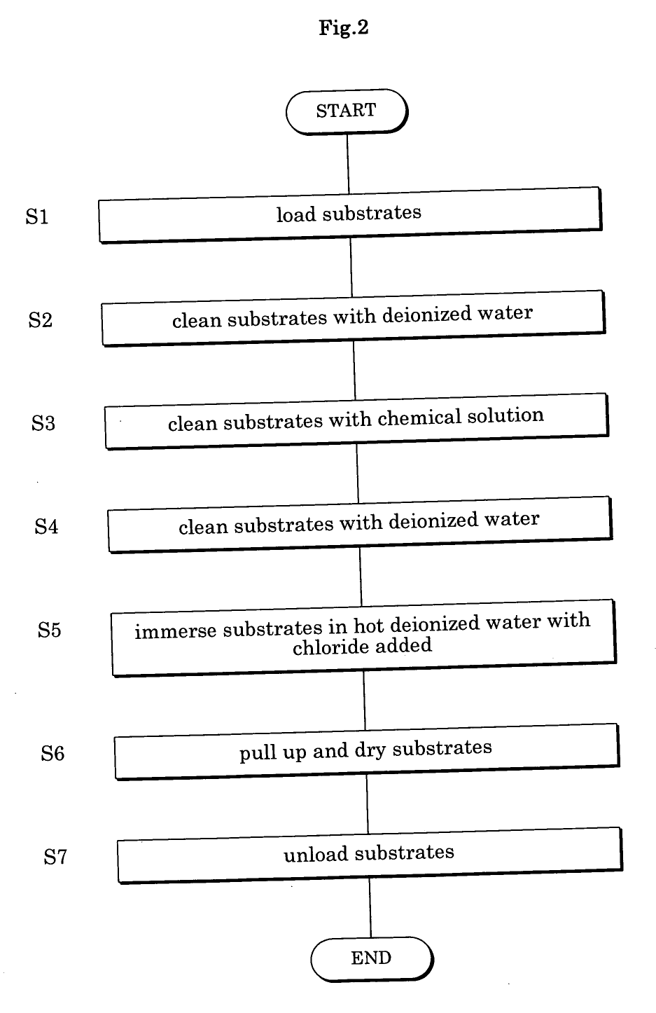

An example of operation of the substrate treating apparatus having the above construction will be described with reference to FIG. 2. FIG. 2 is a flow chart showing operation of the substrate treating apparatus in the first embodiment. Unless otherwise indicated, the following operation of each component is controlled by the controller 51.

<Step S1> Load Substrates:

The blower mechanism 43 pivots about the axis P to open the top of the chamber 5. A substrate transport mechanism, not shown, transports substrates or wafers W into the substrate treating apparatus, and the lifter 1 receives the wafers W from the substrate transport mechanism. After the substrate transport mechanism moves out of the apparatus, the blower mechanism 43 pivots again to close the top of the chamber 5. This places the interior of the chamber 5 in the sealed state.

<Step S2> Clean Substrates with Deionized Water:

The lifter 1 holding the wafers W descends to the treating position in the treating tank 3. By this time, deionized water has already been stored in the treating tank 3. Thus, the wafers W are immersed in the deionized water.

Specifically, only the switch valves 17a and 41a are opened. As a result, deionized water is supplied from the deionized water source 33 into the treating tank 3 through the deionized water pipe 17, common pipe 13 and filling pipes 7. Water currents produced in the treating tank 3 separate a chemical solution, particles and so on from the surfaces of wafers W and scatter these unwanted substances into the deionized water. The deionized water contaminated in this way is discharged from the treating tank 3 by overflowing the top of the treating tank 3, to be collected in the outer tank 9. Cleaning treatment is performed by washing the chemical solution and other substances adhering to the surfaces of wafers W out of the treating tank 3. The deionized water collected in the outer tank 9 is drained through the pipe 41.

Upon lapse of a predetermined time, the switch valve 17a is closed and the switch valve 39a is opened to drain the deionized water from the treating tank 3. When the draining operation is completed, the switch valve 39a is closed again to end the deionized water cleaning treatment.

<Step S3> Clean Substrates with Chemical Solution:

Then, the switch valve 19a is opened. The chemical solution is thereby supplied from the chemical solution source 35 into the treating tank 3. The wafers W are immersed in the chemical solution to undergo cleaning treatment by the chemical solution. Upon lapse of a predetermined time, the switch valve 19a is closed, and the switch valve 39a is opened to drain the chemical solution from the treating tank 3. When the draining operation is completed, the switch valve 39a is closed again to end the chemical solution cleaning treatment.

<Step S4> Clean Substrates with Deionized Water:

The wafers W are cleaned with deionized water through the same procedure as in step S2.

<Step S5> Immerse Substrates in Hot Deionized Water with Chloride Added:

The flow control valves 23 and 27 are opened by predetermined amounts, and the switch valve 15a also is opened. Chloride is thereby supplied at a predetermined flow rate from the chloride source 25 to the mixer 21. Hot deionized water is supplied at a predetermined flow rate from the hot water unit 31 to the mixer 21. The hot deionized water has been heated to the predetermined temperature (85° C.) by the hot water unit 31. The mixer 21 mixes the chloride into the hot deionized water to produce the treating solution. The treating solution produced is supplied into the treating tank 3 through the treating solution pipe 15 and common pipe 13. The wafers W are immersed in this treating solution, whereby thermal energy is transferred from the treating solution to the wafers W. The wafers W store this thermal energy.

At this time, the wafers W are immersed in the treating solution having chloride added to hot deionized water. Therefore, the treating solution contains a larger quantity of hydrogen ions than the quantity of hydrogen ions normally present in deionized water. That is, the treating solution is acid. Consequently, the chemical reaction accompanied by generation of hydrogen ions, i.e. the chemical reaction expressed by chemical formula (1) and chemical formula (2) noted hereinbefore, would further destabilize the system of the treating solution, and is inhibited so that no hydrogen ions may be generated.

Since chloride is a strong acid, a large part thereof ionizes in the treating solution to produce a large quantity of hydrogen ions.

A reaction that produces hydroxide ions from the deionized water contained in the treating solution is inhibited since it is accompanied by generation of hydrogen ions. Thus, the number of moles of hydroxide ions in the treating solution is less than that in deionized water.

Hydroxide ions are known to attack the surfaces of wafers W and etch the wafers W. Consequently, the amount of etching of the wafers W may be reduced in time of the wafers W being immersed in the treating solution, compared with the case of immersion in hot deionized water.

<Step S6> Pull up Substrates:

The lifter 1 is raised from the treating position to the standby position. Nitrogen is blown down from the blower mechanism 43.

The wafers W pulled up from the treating solution are exposed to the surrounding atmosphere. The blower mechanism 43 is blowing down nitrogen from above the wafers W. The wafers W have droplets of the treating solution adhering thereto. These droplets are evaporated promptly by the thermal energy stored in the wafers W and by the downflow of nitrogen.

The droplets adhering to the wafers W at this time are those of the treating solution. Thus, the chemical reaction accompanied by generation of hydrogen ions is inhibited in the droplets also.

The oxidation of the wafers W is accompanied by generation of hydrogen ions. Therefore, the oxidation of the wafers W also is inhibited. In this embodiment, the atmosphere surrounding the wafers W is nitrogen supplied through the blower mechanism 43. However, even if oxygen is present in the atmosphere, the oxidation of the wafers W does not take place, and no oxide of the wafers W is generated. When the droplets evaporate, no oxide deposits on the wafers W, thereby preventing formation of watermarks.

When the wafers W dry completely, the process in step S6 is ended.

<Step S7> Unload Substrates:

The blower mechanism 43 pivots about the axis P to open the top of the chamber 5. The wafers W held by the lifter 1 are delivered to the substrate transport mechanism not shown, to be transported out of the substrate treating apparatus.

Thus, with the substrate treating apparatus in the first embodiment, the oxidation of the wafers W may be inhibited when the wafers W are pulled up from the treating solution having acid added to hot deionized water, for drying treatment of the wafers W. Consequently, no watermark is formed on the wafers W.

By selecting chloride (strong acid) as the acid to be added, the oxidation and etching of the substrates may be suppressed with increased effect.

The apparatus can also inhibit etching of the wafers W when immersed in the treating solution.

The atmosphere around the wafer W can be turned into a low oxygen level atmosphere by causing nitrogen to flow down from the blower mechanism 43. This further inhibits the oxidation of the wafers W.

By using hot deionized water heated to 85° C. by the hot water unit, sufficient thermal energy may be given to the wafers W while the wafers W are immersed in the treating solution. This enhances the performance of drying the wafers W.

With the mixer 21 provided, the treating solution may be produced appropriately from the hot deionized water and chloride.

### Second Embodiment

A second embodiment of this invention will be described hereinafter with reference to the drawings.

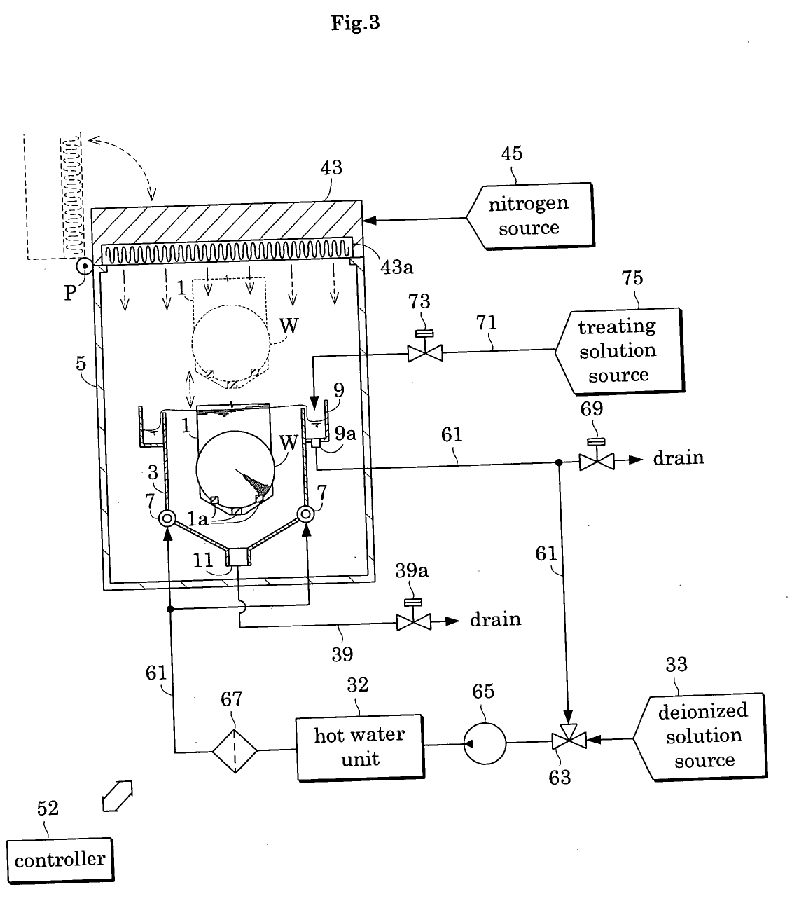

FIG. 3 is a view in vertical section showing an outline of a substrate treating apparatus in the second embodiment. Like reference numerals will be used to identify like parts which are the same as in the first embodiment and will not be described again.

This substrate treating apparatus performs cleaning treatment and drying treatment of wafers W.

A circulating pipe 61 extends between and communicates with the filling pipes 7 arranged in the bottom of the treating tank 3, and the outer tank drain port 9a formed in the bottom of the outer tank 9. The circulating pipe 61 has a three-way valve 63, a circulating pump 65, a hot water unit 32 and a filter 67 arranged thereon in the stated order from the outer tank drain port 9a. The deionized water source 33 is connected to the third end of the three-way valve 63. This arrangement can selectively supply the treating tank 3 with the liquid collected in the outer tank 9 and the deionized water from the deionized water source 33. A branch pipe is connected to the circulating pipe 61 between the outer tank drain port 9a and three-way valve 63 for draining the liquid in circulation. This branch pipe has an electromagnetic switch valve 69 mounted thereon. The circulating pipe 61 corresponds to the treating solution supply device in this invention.

The hot water unit 32 is the same as the hot water unit 31 in the first embodiment, except that this hot water unit 32 controls the temperature of not only the deionized water but also the treating solution. The filter 67 is provided to remove particles from the treating solution.

The outer tank 9 has a forward end of a replenishing pipe 71 extending thereto for replenishing the treating solution. A treating solution source 75 is connected to the replenishing pipe 71 through an electromagnetic switch valve 73. The treating solution supplied from the treating solution source 75 has a predetermined quantity of chloride added to deionized water.

A controller 52 is disposed inside the substrate treating apparatus for performing an overall control of the treatment of wafers W based on predetermined treating conditions. Specifically, the controller 52 causes pivotal movement of the blower mechanism 43 and vertical movement of the lifter 1, to control loading and unloading of the wafers W and position of the wafers W. The controller 52 controls draining of liquids from the treating tank 3 and outer tank 9 by operating the switch valves 39a and 69. Further, the controller 52 operates the hot water unit 32 to control the temperatures of the treating solution in circulation and other solution. The controller 52 operates the switch valve 73 to control supply of the treating solution, thereby to control the quantity of treating solution to be circulated. The controller 52 also operates the nitrogen source 45 to control the blow-off of nitrogen. Further, the controller 52 operates the three-way valve 63 for selectively circulating the treating solution and deionized water. This controller 52 is made up of a central processing unit (CPU) that performs various computations for substrate treatment, and a storage medium that stores the predetermined treating conditions and a variety of information required for substrate treatment. The controller 52 corresponds to the control device in this invention.

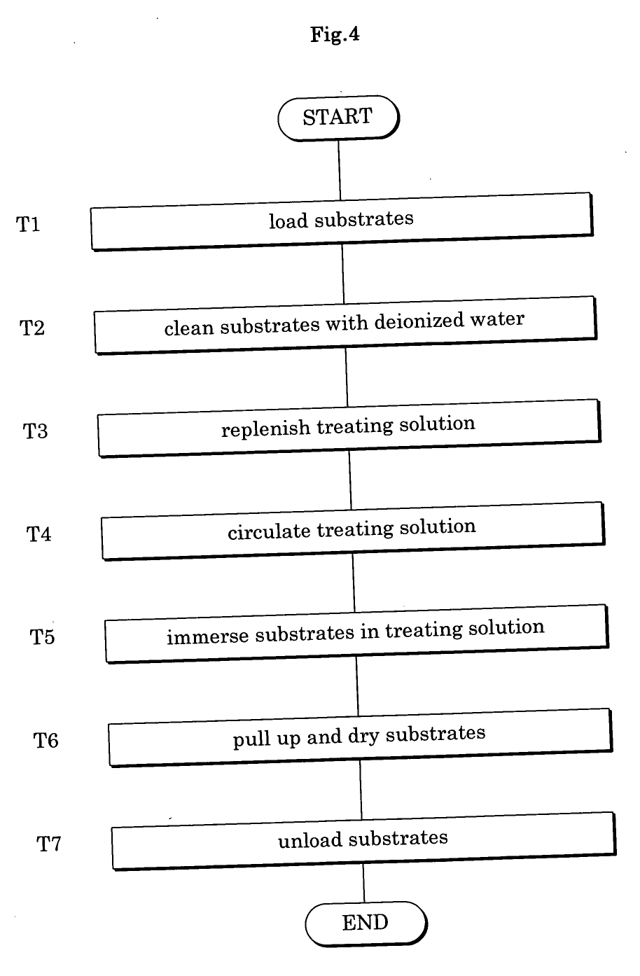

An example of operation of the substrate treating apparatus having the above construction will be described with reference to FIG. 4. Unless otherwise indicated, the following operation of each component is controlled by the controller 52.

<Step T1> Load Substrates:

The lifter 1 receives and holds wafers W loaded into the chamber 5 after the blower mechanism 43 pivots to open the top of the chamber 5.

<Step T2> Clean Substrates with Deionized Water:

The lifter 1 holding the wafers W descends to the treating position in the treating tank 3. By this time, deionized water has already been stored in the treating tank 3. Thus, the wafers W are immersed in the deionized water.

Specifically, the three-way valve 63 is switched for communication with the deionized water source 33. In this state, the switch valves 39a and 73 are closed, and only the switch valve 69 is open. As a result, deionized water is supplied from the deionized water source 33 through the circulating pump 65, hot water unit 32 and filter 67. The deionized water overflowing the top of the treating tank 3 is collected in the outer tank 9. The collected deionized water is drained through the branch pipe without being circulated.

Upon lapse of a predetermined time, the circulating pump 65 is stopped and the switch valve 39a is opened to drain the deionized water from the treating tank 3. After the draining is completed, the switch valve 39a is closed again to end the deionized water cleaning treatment.

<Step T3> Replenish Treating Solution:

The three-way valve 63 is switched for communication with the outer tank 9 and the switch valve 69 is closed. Then, the switch valve 73 is opened. As a result, the outer tank 9 is replenished with the treating solution from the treating solution source 75, thus indirectly supplying the treating solution to the treating tank 3. When the treating solution has been supplied in a predetermined quantity, the switch valve 73 is closed to end the replenishment of the treating solution.

<Step T4> Circulate Treating Solution:

The circulating pump 65 is actuated to circulate the treating solution from the outer tank 9 to the treating tank 3. The treating solution is heated to a predetermined temperature (85° C.) by the hot water unit 32.

<Step T5> Immerse Substrates in Treating Solution:

When the treating solution reaches the predetermined temperature, the lifter 1 is lowered from the standby position to the treating position. Consequently, the wafers W held by the lifter 1 are immersed in the treating solution in the treating tank 3. The thermal energy of the treating solution is transferred to and stored in the wafers W in a predetermined time.

The treating solution is a solution having chloride added to deionized water. Therefore, as in the first embodiment, the amount of etching of the wafers W may be reduced.

<Step T6> Pull up Substrates:

The lifter 1 is raised from the treating position to the standby position. The blower mechanism 43 blows nitrogen down toward the wafers W. The wafers W are thereby dried. The droplets adhering to the wafers W are those of the treating solution as in the first embodiment, which is effective for preventing formation of watermarks.

<Step S7> Unload Substrates:

The blower mechanism 43 pivots about the axis P to open the top of the chamber 5. The wafers W held by the lifter 1 are delivered to the substrate transport mechanism not shown, to be transported out of the substrate treating apparatus.

Thus, with the substrate treating apparatus in the second embodiment, as in the first embodiment, no watermark is formed on the wafers W. The amount of etching of the wafers W may also be reduced.

The second embodiment providing the treating solution source 75 can dispense with the mixer 21 described in the first embodiment.

The second embodiment has the circulating pipe 61 and associated components to form a treating solution circulating system. This provides an advantage of reducing consumption of the treating solution.

This invention is not limited to the embodiments described above, but may be modified as follows:

(1) Each embodiment described above uses a treating solution having chloride added to hot deionized water. Instead of chloride, other acids such as hydrofluoric acid may be used. Instead of being limited to acid, a different substance may be used that can add hydrogen ions to the treating solution.

(2) In the first embodiment, an acid is added by using the mixer 21. Instead, an acid may be added directly to hot deionized water in the treating tank 3 by dripping the acid inside the treating tank 3. When adding an acid in solid or gaseous state, a suitable means such as a gas-liquid mixer may be employed.

(3) Each foregoing embodiment has been described as performing drying treatment, with the treating solution, of substrates after being cleaned with deionized water. However, the treatment preceding the drying treatment is not limited to the deionized water cleaning treatment, but may be varied according to purpose of treatment of the wafers W.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus comprising:
a treating tank for treating substrates;
treating solution supply device for supplying said treating tank with a treating solution having hydrogen ions added to hot deionized water; and
holding device vertically movable, while holding the substrates, between a treating position in said treating tank and a standby position above said treating tank;
wherein said treating solution is stored in said treating tank, and said holding device is raised from said treating position to said standby position to perform drying treatment of the substrates.

2. An apparatus as defined in claim 1, wherein said treating solution is an aqueous solution having an acid added to the hot deionized water.

3. An apparatus as defined in claim 2, wherein said acid is a strong acid.

4. An apparatus as defined in claim 2, wherein said acid is one of chloride and hydrofluoric acid.

5. An apparatus as defined in claim 2, further comprising adding device for adding said acid to the hot deionized water.

6. An apparatus as defined in claim 1, wherein said treating solution is at a temperature of at least 80° C. but below 100° C.

7. An apparatus as defined in claim 1, further comprising control device for controlling supply of said treating solution and vertical movement of said holding device, to store said treating solution in said treating tank, and to raise said holding device from said treating position to said standby position.

8. An apparatus as defined in claim 1, further comprising an outer tank surrounding an upper potion of said treating tank for collecting the treating solution overflowing said treating tank, said treating solution supply device introducing said treating solution into said treating tank from bottom positions thereof.

9. An apparatus as defined in claim 1, further comprising a hot water unit for supplying the hot deionized water.

10. An apparatus as defined in claim 5, wherein said adding device comprises a mixer.

11. An apparatus as defined in claim 1, further comprising a blower mechanism disposed above said treating tank for blowing an inert gas downward.

12. An apparatus as defined in claim 11, wherein said blower mechanism includes a ULPA filter disposed on a blow-off plane thereof.

13. An apparatus as defined in claim 1, further comprising deionized water supply device for supplying deionized water into said treating tank.

14. An apparatus as defined in claim 1, further comprising chemical solution supply device for supplying a chemical solution into said treating tank.

15. A substrate treating method comprising:
a step of immersing substrates in a treating solution having hydrogen ions added to hot deionized water; and
a step of performing drying treatment of the substrates by pulling the substrates up from the treating solution.

16. A method as defined in claim 15, wherein said treating solution is an aqueous solution having an acid added to the hot deionized water.

17. A method as defined in claim 16, wherein said acid is a strong acid.

18. A method as defined in claim 16, wherein said acid is one of chloride and hydrofluoric acid.

19. A method as defined in claim 15, wherein said treating solution is at a temperature of at least 80° C. but below 100° C.

20. A method as defined in claim 15, wherein said step of performing drying treatment is executed while causing an inert gas to flow downward from above the substrates.
